(19) United States
(12) Patent Application Publication
(10) Pub. No.: US 2018/0084872 A1
(43) Pub. Date: Mar. 29, 2018

(54) ANNULAR ELECTRONIC DEVICE

(71) Applicants: BOE TECHNOLOGY GROUP CO., LTD., Beijing (CN); ORDOS YUANSHENG OPTOELECTRONICS CO., LTD., Ordos, Inner Mongolia (CN)

(72) Inventors: Jiamian SUN, Beijing (CN); Chunxiang NAN, Beijing (CN); Liang YUAN, Beijing (CN); Yannan CHEN, Beijing (CN); Lei YUE, Beijing (CN); Qi WANG, Beijing (CN); Zhiming HU, Beijing (CN)

(21) Appl. No.: 15/522,385

(22) PCT Filed: Aug. 25, 2016
(86) PCT No.: PCT/CN2016/096728

§ 371 Date: Apr. 27, 2017

(30) Foreign Application Priority Data
Jan. 18, 2016 (CN) 201610031156.5

(51) Int. Cl. A44C 5/02; G09F 3/00; G04G 9/08; G06F 3/041

(52) U.S. Cl. CPC A44C 5/02; G06F 3/041; G04G 9/08; G09F 3/005

(57) ABSTRACT

An annular electronic device, including at least two curved sections which are connected into a ring, wherein each curved section includes a processing chip and a display panel, in which the display panel is disposed on an external surface of the curved section, and the processing chip is connected with the display panel. The display area of the annular electronic device is adjustable, and can prolong the service life thereof to a certain degree.

### TECHNICAL FIELD

The embodiment of the present disclosure relates to an annular electronic device.

### BACKGROUND

With the development of display technology, display technology has been widely applied in wearable devices such as smart wristbands.

The conventional smart wristband has the same design with watches and includes a band and a dial. The display area of the conventional smart wristband is basically equal to the area of a display on the dial. However, as the area of the display on the dial is small, applications (APPs) on the conventional smart wristband are small, so that users can be difficult to touch and errors may occur.

In order to increase the display area of the smart wristband, some of the existing manufacturers divide the smart wristband into a plurality of ring sections, including a basic ring section and a plurality of optional ring sections, and the basic ring section is configured to control displays of the optional ring sections to achieve display. But if the basic ring section fails, the smart wristband cannot be used.

### SUMMARY

The embodiment of the present disclosure provides an annular electronic device. The display area of the annular electronic device is adjustable. Moreover, the annular electronic device provided by the embodiment of the present disclosure may prolong the service life thereof to a certain degree.

In order to achieve the above objectives, the embodiment of the present disclosure adopts the following technical proposals:

According to at least one embodiment of this disclosure, an annular electronic device is provided, comprising at least two curved sections which are connected into a ring, wherein each curved section includes a processing chip and a display panel, in which the display panel is disposed on an external surface of the curved section, and the processing chip is connected with the display panel.

For example, each curved section further includes a power source; and the processing chip is also connected with the power source.

For example, the at least two curved sections are detachably connected.

For example, in each curved section, the processing chip and the display panel are superimposed.

For example, in each curved section, the power source, the processing chip and the display panel are superimposed.

For example, the processing chip is disposed between the power source and the display panel.

For example, the curved section includes a main body and a first connecting portion and a second connecting portion disposed at two ends of the main body; and at a connecting position of two curved sections, the first connecting portion of one curved section is connected with the second connecting portion of the other curved section.

For example, an internal surface of the first connecting portion is a connecting surface; an external surface of the second connecting portion is a connecting surface; and at a connecting position of two curved sections, a first connecting surface of one curved section and a second connecting surface of the other curved section make contact with each other and are connected with each other.

For example, at a connecting position of two curved sections, the first connecting surface of one curved section and the second connecting surface of the other curved section are connected by magnetic adsorption.

For example, the display panel of the curved section is disposed at corresponding positions of the main body and the first connecting portion; and/or the processing chip of the curved section is disposed at corresponding positions of the main body and the first connecting portion and the second connecting portion; and/or the power source of the curved section is disposed at corresponding positions of the main body and the second connecting portion.

For example, a first interface connected with the processing chip is disposed on the internal surface of the first connecting portion; a second interface connected with the processing chip is disposed on the external surface of the second connecting portion; and at a connecting position of two curved sections, the first interface on the internal surface of the first connecting portion of one curved section is connected with the second interface on the external surface of the second connecting portion of the other curved section, so that the processing chips of the connected two curved sections can be connected.

For example, a first projection is formed on the internal surface of the first connecting portion; a second recess is formed on the external surface of the second connecting portion; and at a connecting position of two curved sections, the first projection of one curved section is engaged with the second recess of the other curved section.

For example, the internal surface of the first connecting portion is also provided with a first recess; the external surface of the second connecting portion is also provided with a second projection; and at a connecting position of two curved sections, the first recess of one curved section is engaged with the second projection of the other curved section.

For example, at a connecting position of two curved sections, the sum of the thickness of the first connecting portion and the second connecting portion is equal to the thickness of the main body.

For example, at least two curved sections are hinged.

For example, the display panel is a flexible display panel.

For example, the length of the curved section is 50 mm-60 mm.

For example, the width of the curved section is 20 mm-50 mm.

For example, the length of the first connecting portion and the second connecting portion is 10 mm-12 mm.

### BRIEF DESCRIPTION OF THE DRAWINGS

In order to make the embodiments of the disclosure apparent, the drawings related to the embodiments of the disclosure will be described briefly. Apparently, the described embodiments are just a part of the embodiments of the disclosure. For those skilled in the art, he or she can obtain other figure(s) according to these figures, without any inventive work.

FIG. 1 is a schematic diagram of an annular electronic device provided by the embodiment of the present disclosure;

FIG. 2 is a schematic structural view of a curved section in the embodiment of the present disclosure;

FIG. 3 is a schematic diagram of a first connecting portion and a second connecting portion on the curved section in the embodiment of the present disclosure;

FIG. 4 is a schematic diagram illustrating the connection of two curved sections in the embodiment of the present disclosure;

FIG. 5 is a schematic diagram of a first connecting portion and a second connecting portion in the embodiment of the present disclosure;

FIG. 6 is a schematic diagram of another first connecting portion and another second connecting portion in the embodiment of the present disclosure;

FIG. 7 is a schematic diagram illustrating the connection of the two connecting portions as shown in FIG. 6; and

FIG. 8 is a schematic diagram illustrating the hinge joint of the first connecting portion and the second connecting portion in the embodiment of the present disclosure.

Reference numerals of the accompanying drawings:

11-power source; 12-processing chip; 13-display panel; 21-first connecting portion; 22-second connecting portion; 100-annular electronic device; 101, 102, 103, 104, 105-curved section; 211-internal surface; 221-external surface.

### DETAILED DESCRIPTION

The technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

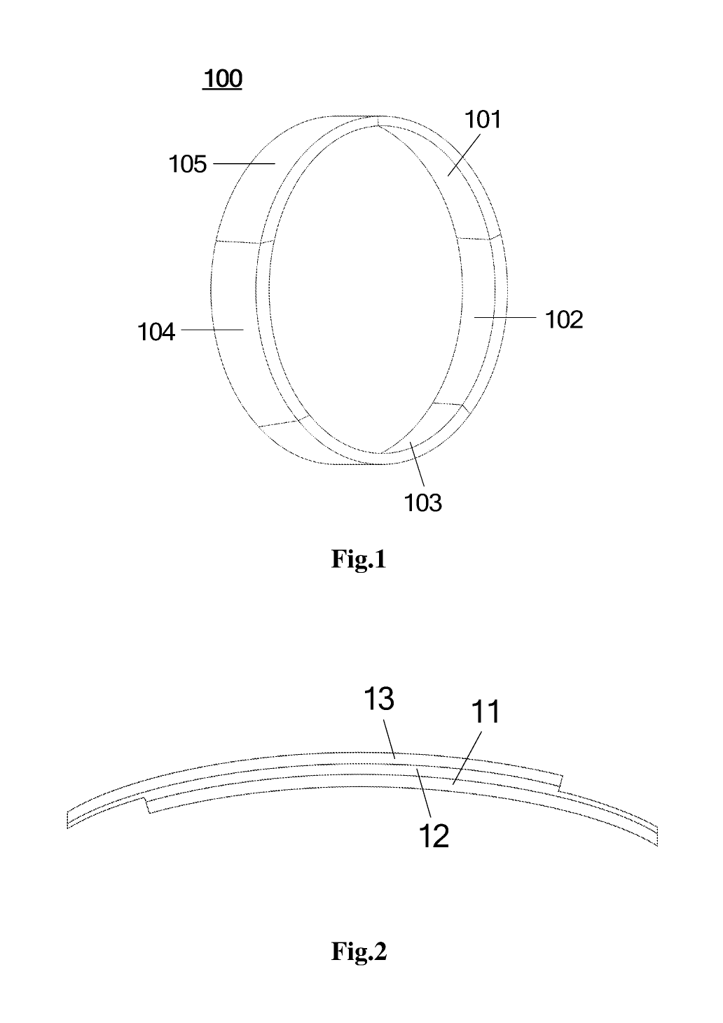

The embodiment of the present disclosure provides an annular electronic device 100, which, as shown in FIG. 1, comprises at least two curved sections which can be connected into a ring. FIG. 1 takes five curved sections as an example, namely a curved section 101, a curved section 102, a curved section 103, a curved section 104 and a curved section 105. As shown in FIG. 2, each curved section includes a processing chip 12 and a display panel 13. Illustratively, each curved section may also include a power source 11. Or only one curved section may include a power source. When each curved section includes the power source, the display panel is disposed on an external surface of the curved section; the processing chip 12 is respectively connected with the power source 11 and the display panel 13; and the display panel 13 is configured to display an image when driven by the processing chip 12.

It should be noted that: in each curved section, the specific setting positions of the power source, the processing chip and the display panel are not limited to those as shown in FIG. 2. Description is given in the present disclosure by only taking those as shown in FIG. 2 as an example. Description is given in the embodiment of the present disclosure by taking the case that the annular electronic device is a smart wristband as an example.

Illustratively, in the 5 curved sections as shown in FIG. 1, each curved section may display different contents or be configured to achieve different functions. For instance, the curved section 101 may be only configured to display time; the curved section 102 may be only configured to display weather; the curved section 103 may be only configured to display position; the curved section 104 may be only configured to monitor body temperature; and the curved section 105 may be only used for step counting. That is to say, each curved section may independently complete one function; even one curved section is damaged, the use of other curved sections will not be affected; and the user may also only repair or detachably connect the damaged curved section.

The annular electronic device provided by the embodiment of the present disclosure comprises at least two curved sections which can be connected into a ring. Each curved section includes a processing chip and a display panel, and the display panel may display an image when driven by the processing chip. Therefore, in the embodiment of the present disclosure, each curved section is an independent display unit, and in the case that batteries are not required for frequent replacement, any curved section may be removed or replaced by a new curved section when being unable to use, so that the use of the annular electronic device can be guaranteed.

Or each curved section includes a processing chip and a display panel, or includes a power source, a processing chip and a display panel. Batteries may be configured to provide electric signals for the display panel and the processing chip, and the display panel may display an image when driven by the processing chip. Therefore, in the embodiment of the present disclosure, each curved section is an independent display unit, and any curved section may be removed or replaced by a new curved section when being unable to use, so that the use of the annular electronic device can be guaranteed.

According to one example of the present disclosure, at least two curved sections may be detachably connected. The number of the curved sections and the functions of the curved sections may be selected for connection according to user demands or the wrist size of the user, so that the annular electronic device capable of achieving different functions can be obtained. The user may customize services according to own needs.

According to one example of the present disclosure, as shown in FIG. 2, in each curved section, the power source 11, the processing chip 12 and the display panel 13 are superimposed. For instance, the display panel 13 is disposed on an external surface of the curved section for display, and the position of the processing chip and the power source may be not specifically limited. Moreover, according to one example of the present disclosure, as shown in FIG. 2, the processing chip 12 is disposed between the power source 11 and the display panel 13, so that the processing chip 12 can be connected with the display panel 13 to control the display panel for display.

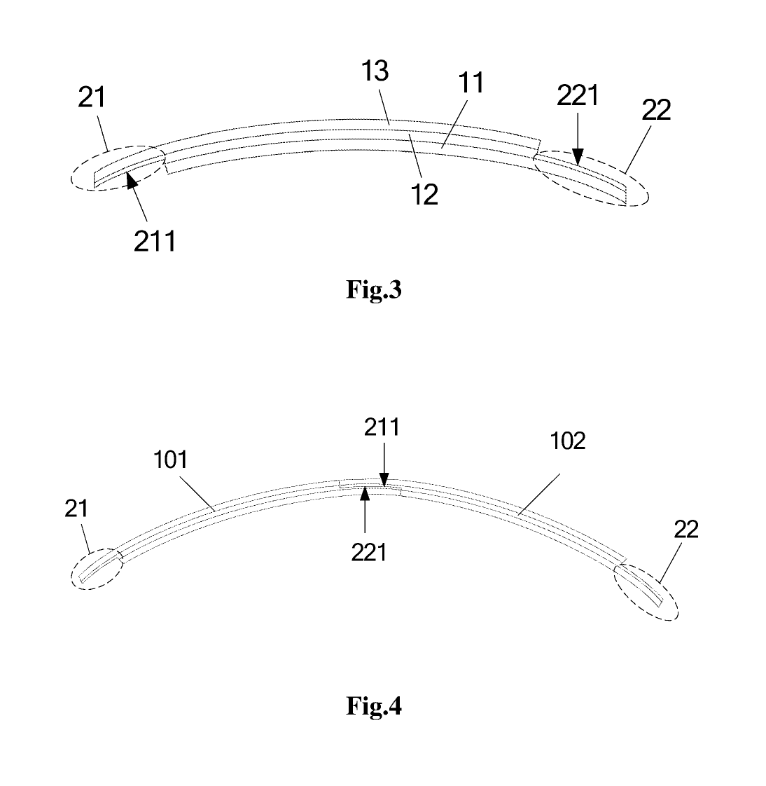

According to one example of the present disclosure, as shown in FIG. 3, the curved section includes a main body and a first connecting portion 21 and a second connecting portion 22 disposed at both ends of the main body. At a connecting position of two curved sections, the first connecting portion 21 of one curved section is connected with the second connecting portion 22 of the other curved section, namely the two curved sections are in end-to-end connection.

For instance, the first connecting portion may be a jack similar to a USB interface, and the second connecting portion may be a plug similar to a USB interface, so that each curved section includes a jack and a plug and can be freely connected.

Of course, that at least two curved sections are detachably connected may be that: both a first connecting end and a second connecting end of one curved section may be plugs similar to USB interfaces, and both a first connecting end and a second connecting end of the other two curved sections connected with the curved section may be jacks similar to USB interfaces. The first connecting end or the second connecting end of the one curved section may be connected with the first connecting end or the second connecting end of the other curved section, so that a plurality of curved sections may also achieve detachable connection.

But at a connecting position of two curved sections, when the first connecting portion of one curved section is connected with the second connecting portion of the other curved section, any two curved sections may be connected. The curved sections have no connection requirement, as long as the use requirement can be satisfied, so the curved sections can be more conveniently selected.

According to one example of the present disclosure, as shown in FIG. 3, in the curved section, the display panel 13 is disposed at corresponding positions of the main body (a part between the first connecting portion and the second connecting portion) and the first connecting portion 21. The processing chip is disposed at corresponding positions of the main body and the first connecting portion and the second connecting portion. The power source is disposed at corresponding positions of the main body and the second connecting portion. Thus, the display panel 13 is disposed at corresponding positions of the main body and the first connecting portion 21, so the display panel has large display area in each curved section. Therefore, display panels in two connected curved sections are disposed on main bodies of the two curved sections and connecting positions of the two curved sections, so the display panels have large display area and can display more or larger APPs.

Moreover, according to one example of the present disclosure, after two adjacent curved sections are connected, the thickness of the two curved sections at connecting positions is the same with the thickness of main bodies of the two curved sections. That is to say, the sum of the thickness of the first connecting portion and the second connecting portion at the connecting positions of the two curved sections is equal to the thickness of the main bodes. Illustratively, as shown in FIG. 3, the thickness of the first connecting portion 21 and the second connecting portion 22 may be respectively half of the thickness of the main body. As shown in FIG. 4 which is a schematic diagram of the two curved sections after connection, the thickness of the two curved sections at the connecting positions is the same with the thickness of the main bodies of the two curved sections. Of course, the description that the thickness of the two curved sections at the connecting positions is the same with the thickness of the main bodies of the two curved sections is not limited to the above preferred embodiments. The thickness of any of the first connecting portion and the second connecting portion may be selectively reduced, and the thickness of the other connecting portion may be correspondingly increased. Or the sum of the thickness of the first connecting portion and the second connecting portion at the connecting positions of the two curved sections may also be equal to the thickness of the main bodies. Description is given in the embodiment of the present disclosure by taking those as shown in FIGS. 3 and 4 as an example.

According to one example of the present disclosure, as shown in FIGS. 3 and 4, an internal surface 211 of the first connecting portion 21 is a connecting surface; an external surface 221 of the second connecting portion 22 is a connecting surface; and at a connecting position of two curved sections, as shown in FIG. 4, taking the connection of the curved section 101 and the curved section 102 as an example, an internal connecting surface 211 of one curved section (namely the curved section 102) makes contact with an external connecting surface 221 of the other curved section (namely the curved section 101), so as to achieve magnetic adsorption connection.

In one aspect, the display area of the annular electronic device can be maximized. For instance, after the magnetic adsorption between the internal surface of the first connecting portion and the external surface of the second connecting portion, the display panels are disposed at corresponding positions of the main bodies and the connections, so the display area of the display panels is large. Moreover, for instance, in the case of bezel-free display panel, the display area of the annular electronic device is basically equal to the area of an external surface of the annular electronic device.

In another aspect, the connection of the two connecting portions is achieved by magnetic adsorption, so that connection can be convenient and operation can be simple. As a first connecting end and a second connecting end are surface contact, the area of magnetic adsorption can be further increased, so that the firmness of the connection can be achieved.

According to one example of the present disclosure, a first interface connected with the processing chip is disposed on the internal surface of the first connecting portion; a second interface connected with the processing chip is disposed on the external surface of the second connecting portion; and at a connecting position of two curved sections, the first interface on the internal surface of the first connecting portion of one curved section is connected with the second interface on the external surface of the second connecting portion of the other curved section, so that the processing chips of the two connected curved sections can be connected.

For instance, when the processing chip is disposed at corresponding positions of the main body and the first connecting portion and the second connecting portion, as the first interface connected with the processing chip is disposed on the internal surface of the first connecting portion and the second interface connected with the processing chip is disposed on the external surface of the second connecting portion, the processing chips of the two curved sections can be more favorably connected. The connection of the processing chips of the curved sections may be implemented by hardware or firmware, and of course, may also be implemented by software. For instance, software for achieving connection is respectively installed in each curved section, and two curved sections may achieve information interaction through the first interface and the second interface, so that the curved sections can be controlled to achieve the combination of functions, and the display of the curved sections can be controlled by software.

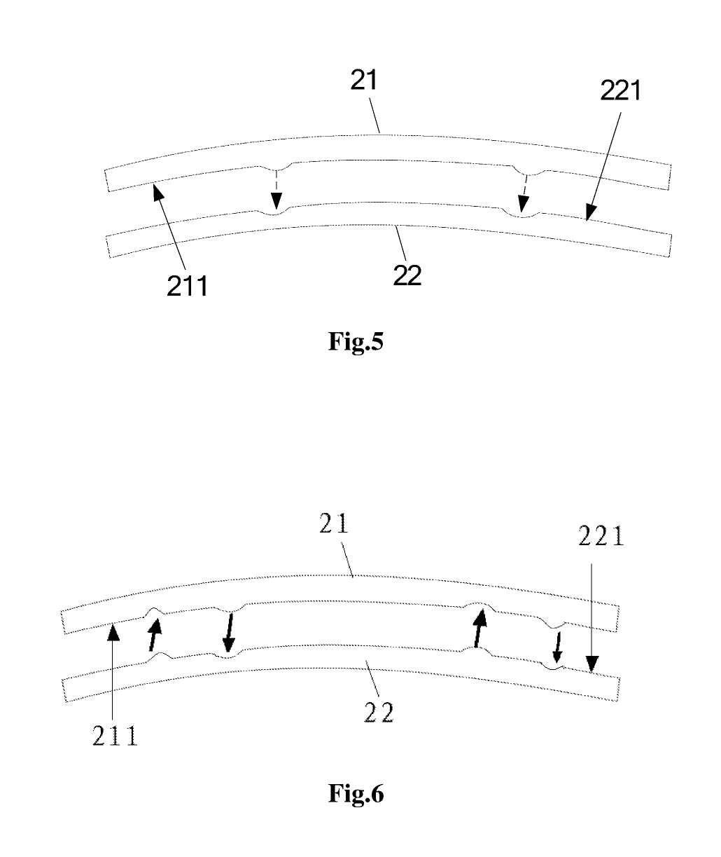

According to one example of the present disclosure, as shown in FIG. 5, a first projection is formed on the internal surface 211 of the first connecting portion 21, and a second recess is formed on the external surface 221 of the second connecting portion 22; and at a connecting position of two curved sections, the first projection on the internal surface 211 of the first connecting portion 21 of one curved section is engaged with the second recess on the external surface 221 of the second connecting portion 22 of the other curved section. As the projection and the recess are formed on the internal surfaces or external surfaces of the connecting portions, after the engagement of the projection and the recess, the relative sliding between the first connecting portion and the second connecting portion can be prevented.

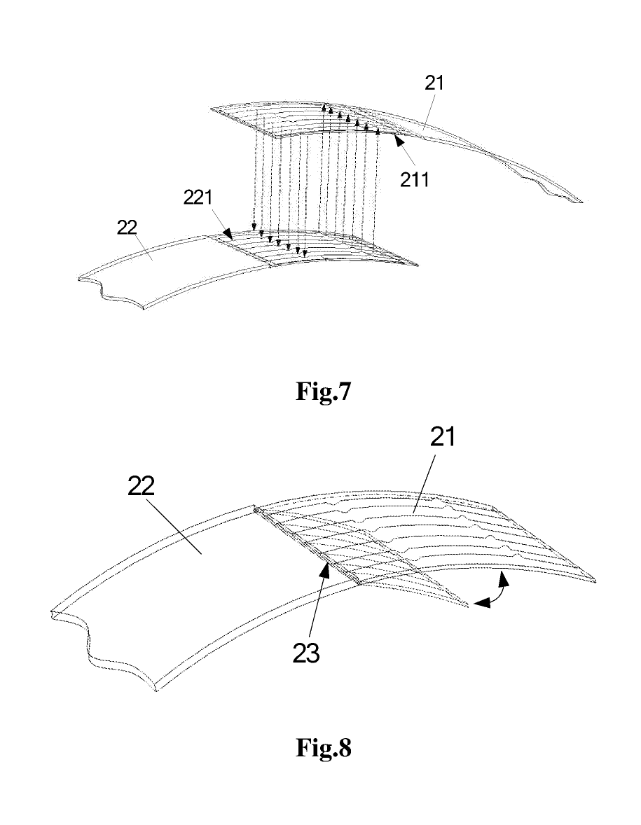

According to one example of the present disclosure, the internal surface of the first connecting portion is also provided with a first recess, and the external surface of the second connecting portion is also provided with a second projection; and at a connecting position of two curved sections, the first recess of one curved section is engaged with the second projection of the other curved section. That is to say, as shown in FIGS. 6 and 7, the internal surface 211 of the first connecting portion 21 and the external surface 221 of the second connecting portion 22 are respectively provided with a projection and a recess; the projection of the first connecting portion 21 is engaged with the recess of the second connecting portion 22; and the recess of the first connecting portion 21 is engaged with the projection of the second connecting portion 22. Thus, when the projection of the first connecting portion 21 cannot be engaged with the recess of the second connecting portion 22, the engagement between the recess of the first connecting portion 21 and the projection of the second connecting portion 22 can be adopted.

According to one example of the present disclosure, at least two curved sections are hinged. Specifically, as shown in FIG. 8, two curved sections may be hinged through a connection shaft 23, so that the two curved sections (namely the first connecting portion 21 and the second connecting portion 22 as shown in FIG. 8) can rotate at a certain angle along the connection shaft 23, and the curved sections are adjusted to be connected into a ring. Of course, it should be understood by those skilled in the art that hinge joint is only a connection means. In the embodiment of the present disclosure, the two curved sections may also be connected by clamping connection, threaded connection, etc.

Of course, the hinge joint of the two curved sections may involve a plurality of embodiments, may specifically refer to the conventional hinge joint means, is not limited to the hinge joint through the connection shaft. Description is given in the embodiment of the present disclosure and the accompanying drawings by only taking the hinge joint through the connection shaft as shown in FIG. 8 as an example.

According to one example of the present disclosure, the display panel is a flexible display panel. As the display panel is a flexible display panel, the curved sections can be more favorably adjusted, and hence the shape of the ring can be adjusted.

In the embodiment of the present disclosure, the total length of the annular display device is also not limited, and may be set by users according to personal preferences. But as the wrist size of the male and the female is usually 140 mm-200 mm, in the embodiment of the present disclosure, according to one example of the present disclosure, the length of the curved section is 50 mm-60 mm. The length of the first connecting portion and the second connecting portion is 10 mm-12 mm. The width of the curved section is 20 mm-50 mm. When the total length of the annular display device is 140 mm, three display sections may be adopted for connection; and when the total length of the annular display device is 200 mm, four display sections may be adopted for connection.

What are described above is related to the illustrative embodiments of the disclosure only and not limitative to the scope of the disclosure. Obvious variations and replacement by any one of the skilled person in the art in the technical scope of the disclosure should be all covered in the scope of this disclosure. The scopes of the disclosure are defined by the accompanying claims.

The application claims priority to the Chinese patent application No. 201610031156.5, filed Jan. 18, 2016, the disclosure of which is incorporated herein by reference as part of the application.

1. An annular electronic device, comprising at least two curved sections which are connected into a ring, wherein
each curved section includes a processing chip and a display panel, in which the display panel is disposed on an external surface of the curved section, and the processing chip is connected with the display panel.

2. The annular electronic device according to claim 1, wherein each curved section further includes a power source; and the processing chip is also connected with the power source.

3. The annular electronic device according to claim 1, wherein the at least two curved sections are detachably connected.

4. The annular electronic device according to claim 1, wherein in each curved section, the processing chip and the display panel are superimposed.

5. The annular electronic device according to claim 2, wherein in each curved section, the power source, the processing chip and the display panel are superimposed.

6. The annular electronic device according to claim 2, wherein the processing chip is disposed between the power source and the display panel.

7. The annular electronic device according to claim 1, wherein the curved section includes a main body and a first connecting portion and a second connecting portion disposed at two ends of the main body; and
at a connecting position of two curved sections, the first connecting portion of one curved section is connected with the second connecting portion of the other curved section.

8. The annular electronic device according to claim 7, wherein an internal surface of the first connecting portion is a connecting surface; an external surface of the second connecting portion is a connecting surface; and
at a connecting position of two curved sections, a first connecting surface of one curved section and a second connecting surface of the other curved section make contact with each other and are connected with each other.

9. The annular electronic device according to claim 8, wherein at a connecting position of two curved sections, the first connecting surface of one curved section and the second connecting surface of the other curved section are connected by magnetic adsorption,

10. The annular electronic device according to claim 7, wherein the display panel of the curved section is disposed at corresponding positions of the main body and the first connecting portion; and/or
the processing chip of the curved section is disposed at corresponding positions of the main body and the first connecting portion and the second connecting portion; and/or
the power source of the curved section is disposed at corresponding positions of the main body and the second connecting portion.

11. The annular electronic device according to claim 7, wherein a first interface connected with the processing chip is disposed on the internal surface of the first connecting portion; a second interface connected with the processing chip is disposed on the external surface of the second connecting portion; and
at a connecting position of two curved sections, the first interface on the internal surface of the first connecting portion of one curved section is connected with the second interface on the external surface of the second connecting portion of the other curved section, so that the processing chips of the connected two curved sections can be connected.

12. The annular electronic device according to claim 7, wherein a first projection is formed on the internal surface of the first connecting portion; a second recess is formed on the external surface of the second connecting portion; and
at a connecting position of two curved sections, the first projection of one curved section is engaged with the second recess of the other curved section.

13. The annular electronic device according to claim 12, wherein the internal surface of the first connecting portion is also provided with a first recess; the external surface of the second connecting portion is also provided with a second projection; and
at a connecting position of two curved sections, the first recess of one curved section is engaged with the second projection of the other curved section.

14. The annular electronic device according to claim 7, wherein at a connecting position of two curved sections, the sum of the thickness of the first connecting portion and the second connecting portion is equal to the thickness of the main body.

15. The annular electronic device according to claim 1, wherein at least two curved sections are hinged.

16. The annular electronic device according to claim 1, wherein the display panel is a flexible display panel.

17. The annular electronic device according to claim 1, wherein the length of the curved section is 50 mm-60 mm.

18. The annular electronic device according to claim 1, wherein the width of the curved section is 20 mm-50 mm.

19. Tile annular electronic device according to claim 7, wherein the length of the first connecting portion and the second connecting portion is 10 mm-12 mm.
